(19) United States
(12) Patent Application Publication
(10) Pub. No.: US 2003/0206780 A1
(43) Pub. Date: Nov. 6, 2003

(54) Spindle assembly for a machine tool

(76) Inventor: Hsi-Kuan Chen, Taichung City (TW)

Correspondence Address: PITNEY, HARDIN, KIPP & SZUCH LLP, 685 THIRD AVENUE, NEW YORK, NY, 10017-4024, US

(21) Appl. No.: 10/039,786

(22) Filed: Jan. 2, 2002

(51) Int. Cl. B23C 5/26

(52) U.S. Cl. 409/233; 408/240

(57) ABSTRACT

A spindle assembly for a machine tool includes a hollow spindle body, a pull rod movable within the spindle body, and a cutter inserted into the spindle body. An insert rod is connected removably to the cutter by an adapter, and is inserted into the spindle body. A chuck unit is disposed within the spindle body, and is retained on the pull rod so as to move with the pull rod. Each of the paw members is formed with an inward flange that is turnable to engage an outward flange on an end of the insert rod when the pull rod is moved within the spindle body, thereby locking the cutter on the spindle body.

### BACKGROUND OF THE INVENTION

1. Field of the Invention

This invention relates to a spindle assembly for a machine tool, and more particularly to a spindle assembly, which includes a cutter and a chuck unit that is movable within a spindle body to lock the cutter on the spindle body.

2. Description of the Related Art

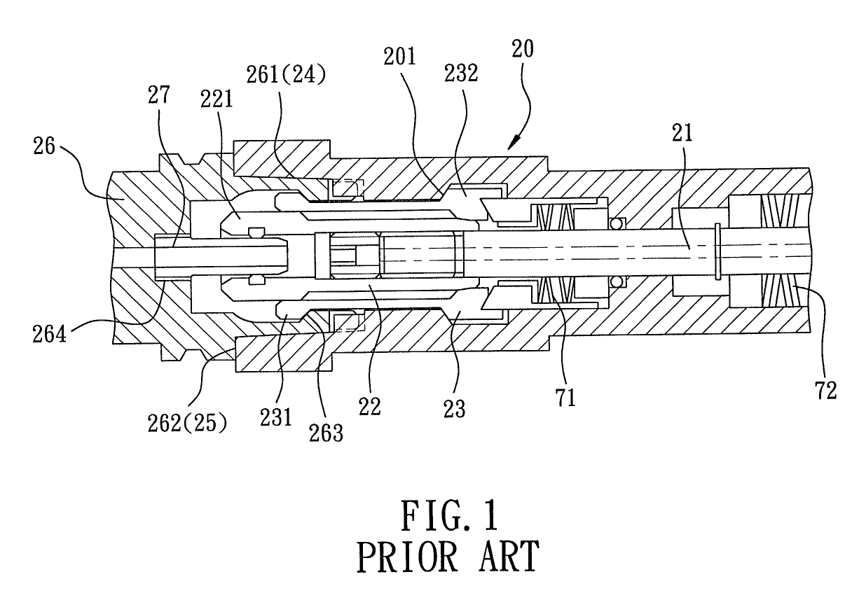

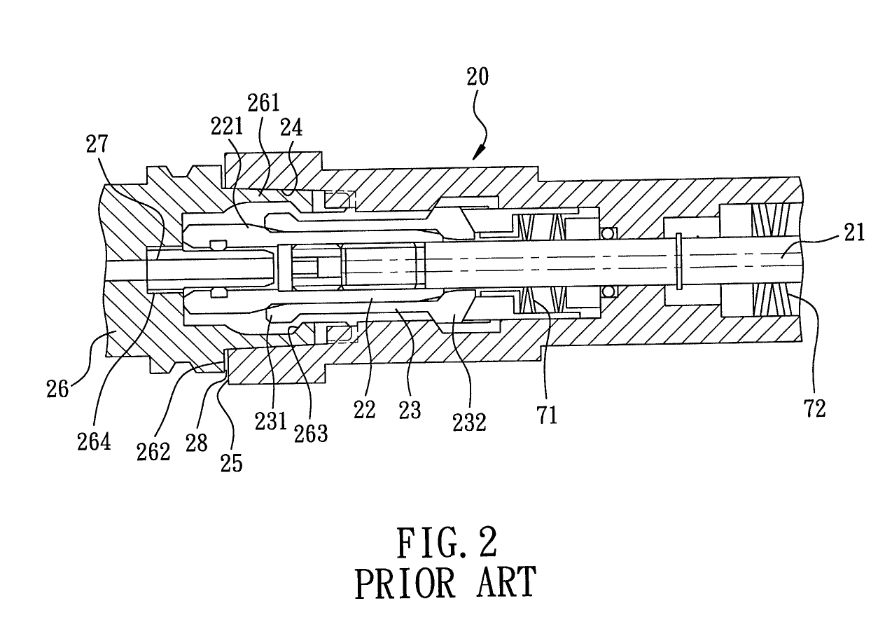

Referring to FIG. 1, a conventional spindle assembly for a machine tool is shown to include a hollow spindle body 20, a pull rod 21, a push rod 22 that is connected fixedly to a front end of the pull rod 21 and that has a front end portion 221 with an increased outer diameter, and a plurality of elongated paw members 23. The spindle body 20 includes a central hole that has a front end 24 in the form of a truncated cone, and a front end surface 25. A hollow cutter 26 is movable between a lock position shown in FIG. 1, and a release position shown in FIG. 2, and includes a rear end 261 that is also shaped as a truncated cone and that engages fittingly the front end 24 of the central hole in the spindle body 20, a shoulder 262 that abuts against the front end surface 24 of the spindle body 20, and an inward flange 263 that extends radially and inwardly from a rear end of the cutter 26. An insert rod 27 is inserted into a front end of the push rod 22, and has an externally threaded front end that engages a threaded hole 264 in the cutter 26. The paw members 23 have enlarged front ends 231 that are disposed within the cutter 26 and that are clamped between the front end portion 221 of the push rod 22 and the inward flange 263 of the cutter 26, and enlarged rear ends 232 that are disposed within the spindle body 20 and that are clamped between a rear end of the push rod 22 and a shoulder 201 of the spindle body 20. As such, the cutter 26 is fixed within the front end 24 of the central hole in the spindle body 20. A front resilient member 71 is disposed in the spindle body 20 for biasing the paw members 23 forwardly. A rear resilient member 72 is also disposed in the spindle body 20 for biasing the pull rod 21 forwardly.

During assembly, the pull rod 21, the paw members 23, and the front and rear resilient members 71, 72 are mounted in place within the spindle body 20. The insert rod 27 is mounted threadedly on the cutter 26, while the push rod 22 is mounted fixedly on the pull rod 21. Subsequently, the cutter 26 is inserted into the spindle body 20 such that a space 28 is formed between the shoulder 262 of the cutter 26 and the front end surface 25 of the spindle body 20, as shown in FIG. 2. Finally, the pull rod 21 is pulled rearward within the spindle body 20 by means of a hydraulic device or a pneumatic device so that the front end portion 221 of the push rod 22 presses the front ends 231 of the paw members 23 against the inward flange 263 of the cutter 26 and so that the rear end of the push rod 22 presses the rear end 232 of the paw members 23 against the shoulder 201 of the spindle body 20 with the assistance of the front resilient member 71, as shown in FIG. 1, thereby locking the cutter 26 on the spindle body 20.

Because there is a need for a relatively high manufacturing precision in order to lock the cutter 26 effectively on the spindle body 20, it is necessary to conduct a finishing operation on most of the molded parts in the spindle body 20 and the cutter 26. However, the aforesaid conventional spindle assembly consists of numerous parts, thereby resulting in a complex structure and difficulties during manufacture.

### SUMMARY OF THE INVENTION

The object of this invention is to provide a spindle assembly for a machine tool, which has a relatively simple structure and which is easy to manufacture.

According to this invention, a spindle assembly for a machine tool includes a hollow spindle body, a pull rod movable within the spindle body, and a cutter inserted into the spindle body. An insert rod is connected removably to the cutter by an adapter, and is inserted into the spindle body. A chuck unit is disposed within the spindle body, and is retained on the pull rod so as to move with the pull rod. Each of the paw members is formed with an inward flange that is turnable to engage an outward flange on an end of the insert rod when the pull rod is moved within the spindle body, thereby locking the cutter on the spindle body. As such, the structure of the spindle assembly is relatively simple. Furthermore, because the insert rod is connected to the cutter by means of the adapter, it can be a component with a uniform specification, which is available in the market, and the cutter can be a component that complies with an international standard and that is also available in the market. The precision requirement of the adapter is relatively low during assembly such that the spindle assembly can be manufactured with relative ease.

### BRIEF DESCRIPTION OF THE PREFERRED EMBODIMENT

These and other features and advantages of this invention will become apparent in the following detailed description of a preferred embodiment of this invention, with reference to the accompanying drawings, in which:

FIG. 1 is a fragmentary longitudinal sectional view of a conventional spindle assembly for a machine tool to illustrate a cutter when disposed at a lock position;

FIG. 2 is a fragmentary longitudinal sectional view of the conventional spindle assembly to illustrate the cutter when disposed at a release position;

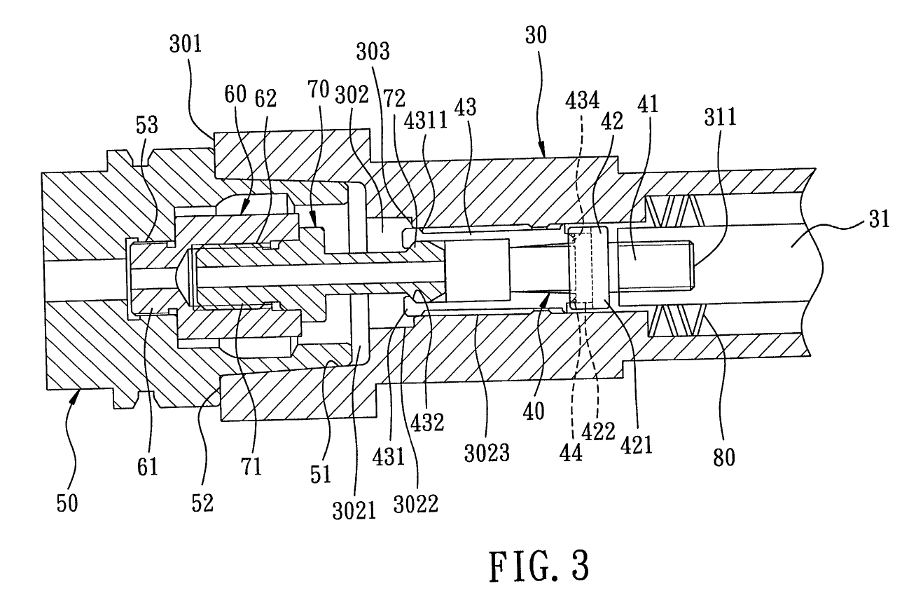

FIG. 3 is a fragmentary longitudinal sectional view showing the preferred embodiment of a spindle assembly for a machine tool according to this invention, illustrating a cutter when disposed at a lock position;

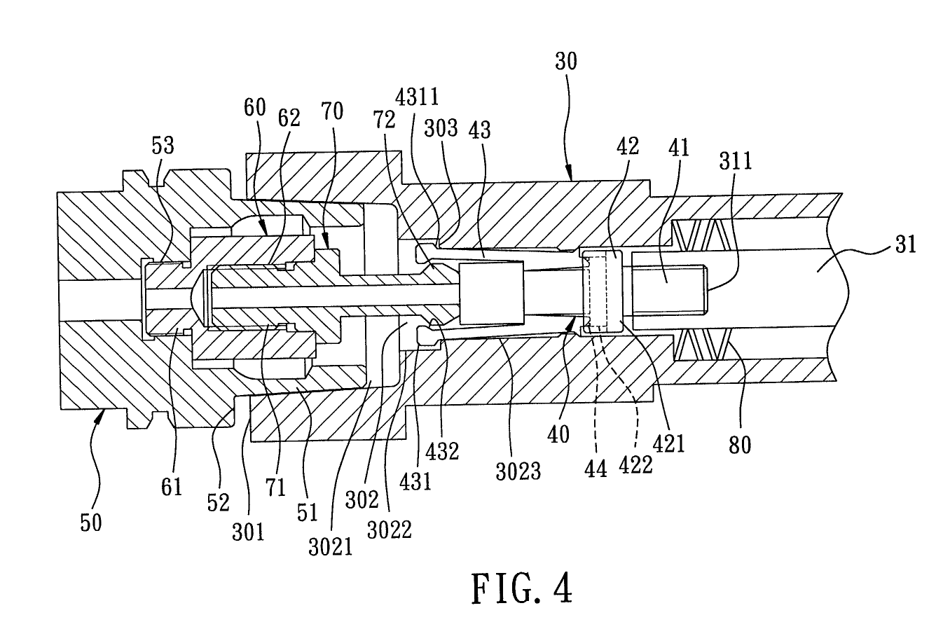

FIG. 4 is a fragmentary longitudinal sectional view of the preferred embodiment to illustrate the cutter when disposed at a release position;

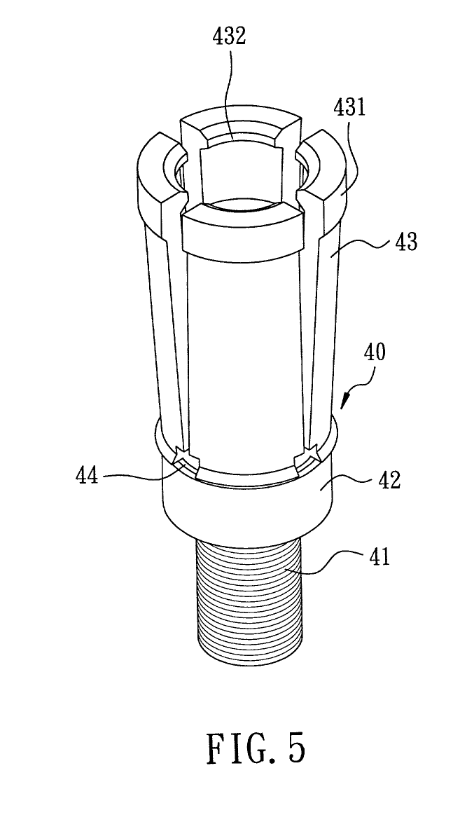

FIG. 5 is an assembled perspective view showing a chuck unit of the preferred embodiment;

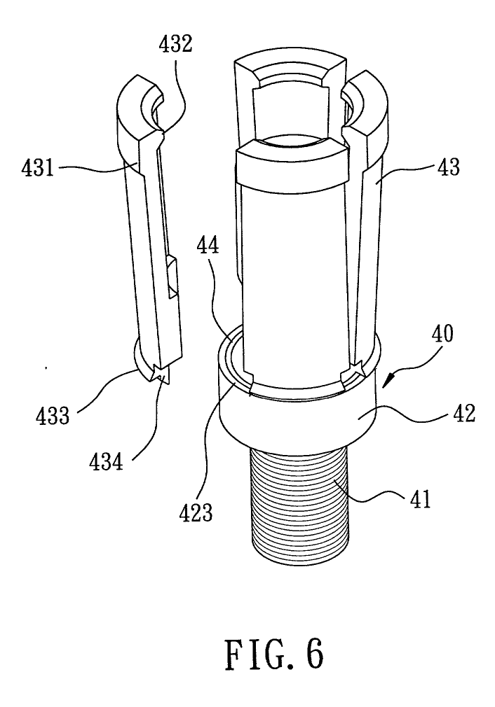

FIG. 6 is a partly exploded perspective view showing the chuck unit of the preferred embodiment; and

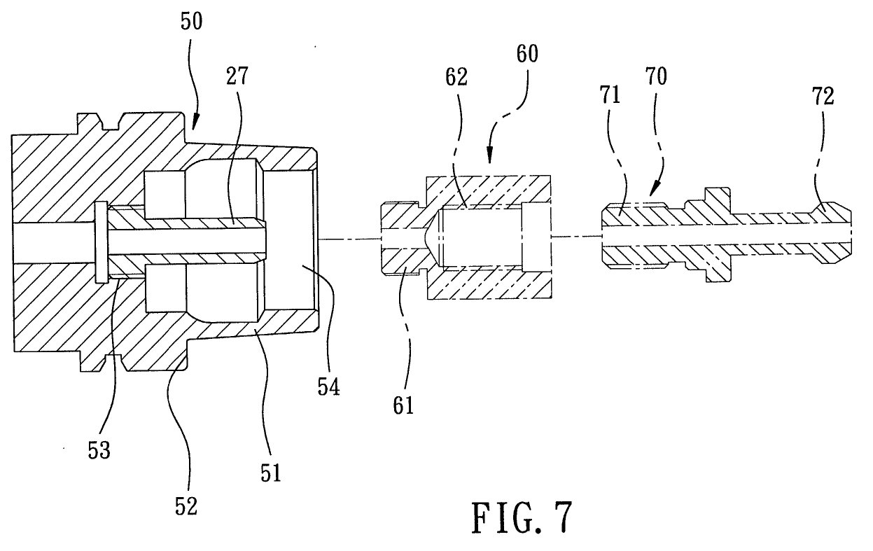

FIG. 7 is an exploded sectional view showing a cutter, an adapter, and an insert rod of the preferred embodiment.

### DESCRIPTION OF THE PREFERRED EMBODIMENT

Referring to FIG. 3, the preferred embodiment of a spindle assembly for a machine tool according to this invention is shown to include a hollow spindle body 30, a chuck unit 40, a cutter 50, an adapter 60, an insert rod 70, and a resilient member 80.

The spindle body 30 has a front end surface 301 that is formed with a central hole 302, and an inner wall that is formed with a pushing edge 303. The central hole 302 has a front end 3021, a large-diameter front portion 3022, and a small-diameter rear portion 3023 that is smaller than the large-diameter front portion 3022 in diameter. The front end 3021 is shaped as a truncated cone that increases forwardly and gradually in diameter. The pushing edge 303 is shaped as a shoulder that is defined between the front portion 3022 and the rear portion 3023 of the central hole 302.

Referring to FIGS. 3, 5, and 6, the chuck unit 40 includes an externally threaded rod body 41, a hollow cylindrical element 42 that is disposed in front of the rod body 41, a plurality of paw members 43 that are disposed in front of the cylindrical element 42, and an O-ring 44 that is disposed within the cylindrical element 42.

A pull rod 31 is disposed axially and movably within the spindle body 30, and is biased by the resilient member 80 to a position shown in FIG. 4 when no external force is applied thereon.

The rod body 41 engages a threaded hole 311 in a front end surface of the pull rod 31, thereby fixing the rod body 41 to the pull rod 31.

The cylindrical element 42 has a circular rear end wall 421 that is fixed to a front end of the rod body 41, an annular surrounding wall 422 that is formed integrally with an outer periphery of the rear end wall 421, and an annular front end surface 423.

The paw members 43 are arranged as a hollow cylinder. Each of the paw members 43 has a front end, which is formed with a front outward flange 431 that projects integrally, radially and outwardly therefrom, and an inward flange 432 that projects integrally, radially and inwardly therefrom. Each of the front outward flanges 431 has an inclined rear edge 4311. A rear end portion of each of the paw members 43 is formed with a rear outward flange 433 that projects integrally, radially, and outwardly therefrom and that abuts against the front end surface 423 of the cylindrical element 42, and a rearwardly projecting rear distal end 434 that is disposed behind the rear outward flange 433.

The O-ring 44 is sleeved fixedly on the rear distal ends 434 of the paw members 43, and is press fitted within the surrounding wall 422 of the cylindrical element 42, thereby retaining the paw members 43 on the cylindrical element 42. As such, the paw members 43 are retained on and are turnable relative to the cylindrical element 42 in such a manner that the front ends of the paw members 43 rotate respectively about the rear distal ends 434 of the paw members 43.

Referring to FIGS. 3 and 7, the cutter 50 has a rear end 51 that is shaped as a truncated cone and that is disposed movably within the front end 3021 of the central hole 302 in the spindle body 30, an outer surface that is formed with a shoulder 52, an internal thread portion 53, and a rear end surface that is formed with a central hole 54. In this embodiment, the cutter 50 is a hollow cutter that complies with the HSK standard set by ISO (International Standards Organization).

The cutter 50 is movable relative to the spindle body 30 between a lock position shown in FIG. 3, where the shoulder 52 of the cutter 50 abuts against the front end surface 301 of the spindle body 30, and a release position shown in FIG. 4, where the shoulder 52 of the cutter 50 is spaced apart from the front end surface 301 of the spindle body 30. The resilient member 80, which is disposed within the spindle body 30, biases the cutter 50 from the lock position to the release position. The pull rod 31 can be moved rearward within the spindle body 30 against the biasing action of the resilient member 80 by means of a hydraulic device or a pneumatic device in a known manner so as to move the cutter 50 from the release position to the lock position.

The adapter 60 is disposed within the central hole 54 in the cutter 50, and has a front end that is formed with an external thread portion 61 for engaging the internal thread portion 53 of the cutter 50, and a rear end surface that is formed with a threaded hole 62.

The insert rod 70 has an externally threaded front end 71 that engages the threaded hole 62 in the adapter 60 so as to fix the insert rod 70 to the adapter 60, and a rear end, which is formed integrally with an outward flange 72 that projects radially and outwardly therefrom. In this embodiment, the insert rod 70 is a component with a uniform specification (MAS 403-P40T), which is available in the market.

During assembly, the pull rod 31 and the resilient member 80 are mounted in place within the spindle body 30. The adapter 60 is connected threadedly to the insert rod 70 and the cutter 50. The chuck unit 40 is connected threadedly to the pull rod 31. Subsequently, the rear end 51 of the cutter 50 is inserted into the front end 3021 of the central hole 302 in the spindle body 30 so as to locate the cutter 50 at the release position shown in FIG. 4, where the rear end of the insert rod 70 is inserted into the chuck unit 40 and where the outward flange 72 of the insert rod 70 is disposed behind the inward flanges 432 of the paw members 43. Finally, the pull rod 31 is moved rearward within the spindle body 30 so that the inclined rear edges 4311 of the front outward flanges 431 of the paw members 43 slide on the pushing edge 303 of the spindle body 30. As such, the inward flanges 432 of the paw members 43 turn inward to engage the outward flange 72 of the insert rod 70 when the cutter 50 is disposed at the lock position shown in FIG. 3, thereby locking the cutter 50 on the spindle body 30.

The spindle assembly of this invention has the following advantages:

1. When the cutter 50 is disposed at the lock position, because the inward flanges 432 engage the outward flange 72, the cutter 50 can be locked firmly on the spindle body 30.

2. The cutter 50 is locked on the spindle body 30 by virtue of engagement between the insert rod 70 and the chuck unit 40, thereby resulting in a simple structure for the spindle assembly.

3. Because the cutter 50 complies with an international standard, it can be replaced easily and conveniently with a new one.

4. The insert rod 70 has a uniform specification, and is available in the market. The manufacturing precision requirement of the adapter 60 is relatively low. Accordingly, the spindle assembly can be manufactured with relative ease, thereby resulting in lower manufacturing costs.

With this invention thus explained, it is apparent that numerous modifications and variations can be made without departing from the scope and spirit of this invention. It is therefore intended that this invention be limited only as indicated by the appended claims.

I claim:

1. A spindle assembly for a machine body, said spindle assembly comprising:
a hollow spindle body having a front end surface that is formed with a central hole, and an inner wall that is formed with a pushing edge, said central hole having a front end which is shaped as a truncated cone that increases forwardly and gradually in diameter;
a hollow cutter having an outer surface that is formed with a shoulder, a rear end that is shaped as a truncated cone and that is disposed movably within said front end of said central hole in said spindle body, a rear end surface that is formed with a central hole, and an internal thread portion, said cutter being movable relative to said spindle body between a lock position, where said shoulder of said cutter abuts against said front end surface of said spindle body, and a release position, where said shoulder of said cutter is spaced apart from said front end surface of said spindle body;
a resilient member disposed within said spindle body for biasing said cutter to said release position;
an adapter disposed within said central hole in said cutter and having a front end that is formed with an external thread portion for engaging said internal thread portion of said cutter so as to fix said adapter to said cutter, and a rear end surface that is formed with a threaded hole;
an insert rod having an externally threaded front end that engages said threaded hole in said adapter so as to fix said insert rod to said adapter, and a rear end, which is formed integrally with an outward flange that projects radially and outwardly therefrom;
a pull rod disposed axially and movably within said spindle body; and
a chuck unit attached to said pull rod and including a plurality of paw members, which are arranged as a hollow cylinder and which have front ends, and rear ends that are connected to said pull rod so that said paw members are turnable relative to said pull rod and so that said front ends of said paw members are rotatable respectively about said rear ends of said paw members, said front end of each of said paw members being formed with an inward flange that projects integrally, radially and inwardly therefrom, and a front outward flange that projects integrally, radially and outwardly therefrom, said pull rod being movable rearward within said spindle body against biasing action of said resilient member so as to move said cutter from said release position to said lock position, said paw members sliding on said pushing edge of said spindle body during movement of said cutter from said release position to said lock position so that said front outward flanges of said paw members are pushed radially and inwardly by said pushing edge of said spindle body to turn inward such that said inward flanges of said paw members press against a front end of said outward flange of said insert rod when said cutter is disposed at said lock position, thereby locking said cutter on said spindle body.

2. The spindle assembly as claimed in claim 1, wherein said central hole in said spindle body has a large-diameter front portion and a small-diameter rear portion that is smaller than said large-diameter front portion in diameter, thereby defining a shoulder that is disposed between said large-diameter front portion and said small-diameter rear portion and that constitutes said pushing edge, said front outward flange of each of said paw members having an inclined rear edge, which is slidable on said shoulder of said spindle body during rearward movement of said pull rod within said spindle body so as to turn inward said inward flanges of said paw members to engage said outward flange of said insert rod.

3. The spindle assembly as claimed in claim 1, wherein said chuck unit further includes:
a rod body connected removably to said pull rod and having a front end;
a hollow cylindrical element having a circular rear end wall fixed to said front end of said rod body, an annular surrounding wall that is formed integrally with an outer periphery of said rear end wall, and an annular front end surface;
each of said paw members having a rear outward flange that projects integrally, radially, and outwardly from a rear end portion thereof and that abuts against said front end surface of said cylindrical element, and a rearwardly projecting rear distal end that is disposed behind said rear outward flange; and
an O-ring sleeved fixedly on said rear distal ends of said paw members and press fitted within said surrounding wall of said cylindrical element, thereby retaining said paw members on said cylindrical element.

4. The spindle assembly as claimed in claim 3, wherein said pull rod has a front end surface that is formed with a threaded hole, said rod body of said chuck unit being externally threaded to engage said threaded hole in said pull rod.
